(19) United States
(12) Patent Application Publication
(10) Pub. No.: US 2009/0164444 A1
(43) Pub. Date: Jun. 25, 2009

(54) METHOD OF WEB AD MONETIZATION BEYOND SEARCH ENGINE

(76) Inventor: Jagadeshwar R. Nomula, Sunnyvalc, CA (US)

Correspondence Address: STATTLER - SUH PC, 60 SOUTH MARKET STREET, SUITE 480, SAN JOSE, CA, 95113, US

(21) Appl. No.: 11/960,168

(22) Filed: Dec. 19, 2007

(51) Int. Cl. G06F 17/30

(52) U.S. Cl. 707/5; 707/3; 707/E17.108

(57) ABSTRACT

A method and system are provided for web ad monetization beyond a search engine. In one example, a method is provided for passing search intent to a publisher web server is provided. The method includes receiving a search query from a consumer, calculating relevant search results based on the search query, returning relevant search results to the consumer, receiving a click selection of a search result from the consumer, logging search query information and user click information, redirecting the consumer to a website of the publisher web server, and sending the search intent to the publisher web server.

### FIELD OF THE INVENTION

The present invention relates to web ads. More particularly, the present invention relates to monetizing on web ads with entities other than a search engine.

### BACKGROUND OF THE INVENTION

An advertiser, such as Ford® or McDonald's®, generally contracts an advertising agency for ads in different media for its products. Such media may include banner display ads, text ads, streaming ads and mobile phone ads. It is quite possible that the advertiser may engage one or more advertising agencies that specialize in creating ads for one or more of the above media. The advertising agencies employ ad servers, ad networks and ad exchanges to distribute ads they have created. A search engine, publisher or ad agency of an advertisement is interested in ways in which an ad may be monetized besides merely at the search engine level.

A user typically goes to a search engine such as Yahoo!® or Google® and types in a query and gets some search results. The user then clicks these search results and lands on content pages of a publisher site. Theses landing pages typically either have display ads or content ads in addition to content. The text ads are displayed by analyzing the content of a landing web page. Display ads are displayed based on a mix of behavioral targeting and direct booking of advertisers on the landing pages of publishers. Search query is instant gratification for advertisers and is probably the best monetize-able trigger for advertisers on the internet.

A search engine calculates search intent based on the user's query. Search intent is ultimately an indication of where the user intends to go or what interests the user has. Search intent may be merely the key words entered for the query; search intent may also be a more elaborate calculation of the user's intent based on those keywords. Unfortunately, publishers of web pages on the internet other than the search engines have no way of monetizing search intent because web pages are disconnected from the search engines.

### SUMMARY OF THE INVENTION

What is needed is an improved method having features for addressing the problems mentioned above and new features not yet discussed. Broadly speaking, the present invention fills these needs by providing a method and system of web ad monetization beyond a search engine. It should be appreciated that the present invention can be implemented in numerous ways, including as a method, a process, an apparatus, a system or a device. Inventive embodiments of the present invention are summarized below.

In one embodiment, a method for passing search intent to a publisher web server is provided. The method comprises receiving a search query from a consumer, calculating relevant search results based on the search query, returning relevant search results to the consumer, receiving a click selection of a search result from the consumer, logging search query information and user click information, redirecting the consumer to a website of the publisher web server, and sending the search intent to the publisher web server.

In another embodiment, an apparatus for passing search intent to a publisher web server is provided. The apparatus comprises a receiver device configured to receive a search query from a consumer, a processor device configured to calculate relevant search results based on the search query, and a sender device configured to return relevant search results to the consumer, wherein the receiver is further receive a click selection of a search result from the consumer, wherein the processor device is further configured to log search query information and user click information, wherein the processor device is further configured to redirect the consumer to a website of the publisher web server, and wherein the sender device is further configured to send the search intent to the publisher web server.

In still another embodiment, an apparatus for receiving search intent from a publisher web server is provided. The apparatus comprises a receiver device configured to receive the search intent from a publisher web server, a process device configured to customize the search intent and to optimize an ad to create an optimized ad, and a sender device configured to send the optimized ad to the publisher web server.

In yet another embodiment, a method of passing search intent to one or more ad servers is provided. The method comprises receiving a search query from a consumer, calculating relevant search results based on the search query, returning relevant search results to the consumer, receiving a click selection of a search result from the consumer, logging search query and user click information, and sending the search intent to the one or more ad servers.

In still yet another embodiment, an apparatus for passing search intent to one or more ad servers is provided. The apparatus comprises a receiver device configured to receive a search query from a consumer, a processor device configured to calculate relevant search results based on the search query, and a sender device configured to return relevant search results to the consumer, wherein the receiver device is further configured to receive a click selection of a search result from the consumer, wherein the processor device is further configured to log search query and user click information, and wherein the sender device if further configured to send the search intent to the one or more ad servers.

In yet still another embodiment, an apparatus for receiving search intent from a search web server is provided. The apparatus comprises a receiver device configured to receive a search intent from the search web server, a processor device configured to customize the search intent and to optimize the search intent to create an optimized ad, and a sender device configured to send the optimized ad to a publisher web server.

In another embodiment, a computer readable medium carrying one or more instructions for passing search intent to a publisher web server is provided. The one or more instructions, when executed by one or more processors, cause the one or more processors to perform the steps of receiving a search query from a consumer, calculating relevant search results based on the search query, returning relevant search results to the consumer, receiving a click selection of a search result from the consumer, logging search query information and user click information, redirecting the consumer to a website of the publisher web server, and sending the search intent to the publisher web server.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a schematic diagram of a system configured to send search intent to a publisher, in accordance with an embodiment of the present invention; and

FIG. 2 is a schematic diagram of a system configured to send search intent to an ad network or ad exchange, in accordance with an embodiment of the present invention;

FIG. 3 is a flowchart of a method carried out by a search web server involving passing search intent from the search web server to a publisher web server, in accordance with an embodiment of the present invention;

FIG. 4 is a flowchart of a method carried out by a publisher web server involving passing search intent to an ad server, in accordance with an embodiment of the present invention;

FIG. 5 is a flowchart of a method carried out by an ad server involving receiving search intent from a publisher web server, in accordance with an embodiment of the present invention;

FIG. 6 is a flowchart of a method carried out by a search web server involving passing search intent to an ad network or ad exchange, in accordance with an embodiment of the present invention; and

FIG. 7 is a flowchart of a method carried out by an ad server involving receiving search intent from a search web server, in accordance with an embodiment of the present invention.

### DETAILED DESCRIPTION OF THE INVENTION

An invention for web ad monetization beyond a search engine is disclosed. Numerous specific details are set forth in order to provide a thorough understanding of the present invention. It will be understood, however, to one skilled in the art, that the present invention may be practiced with other specific details.

The method involves sending the search intent to publisher, ad-network, or ad-exchange. Each of these entities can use search intent to target ads more effectively and to monetize on advertisements. Search intent may be merely the key word(s) entered for the query, for example, “digital camera”. Search intent may also be a sophisticated calculation of the user's intent based on those keywords.

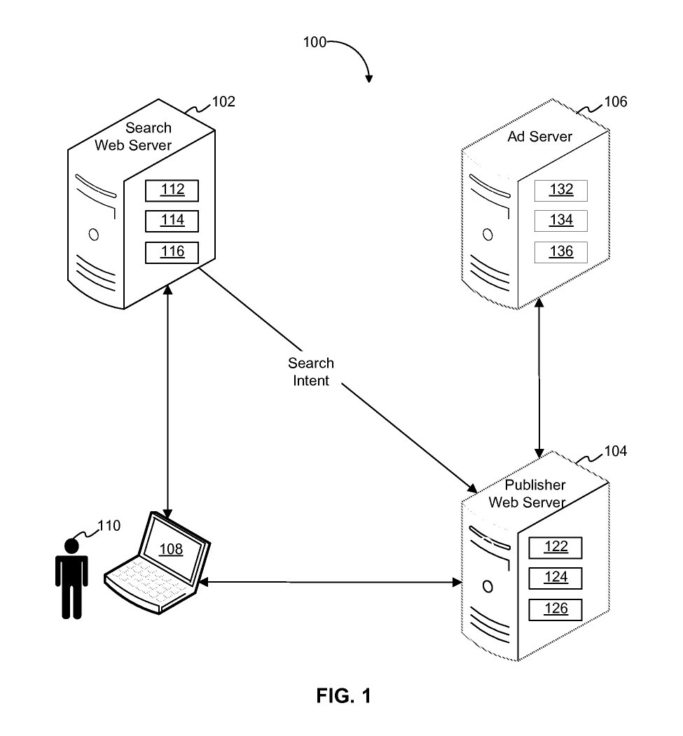

FIG. 1 is a schematic diagram of a system 100 configured to send search intent to a publisher, in accordance with an embodiment of the present invention. The system includes, but is not limited to, a search web server 102, a publisher web server 104 and an ad server 106. The search web server 102 is coupled to the publisher web server 104, which is coupled to the ad server 106. Each of these apparatuses includes devices configured to carry out methods of the present invention. Each device is configured to carry out one or more steps of a method of the present invention. A device is hardware, software or a combination thereof. The search web server 102 includes, but is not limited to, a receiver device 112, a processor device 114 and a sender device 116. The publisher web server 104 includes, but is not limited to, a receiver device 122, a processor device 124 and a sender device 126. The ad server 106 includes, but is not limited to, a receiver device 132, a processor device 134 and a sender device 136.

The publisher web server 104 does not host the ads. The ad server 106 hosts the ads. The ad server 106 may be part of a larger ad-network/ad-exchange. An ad exchange is a conglomeration of different ad networks. An ad network includes various ad servers 106. Ad agencies handle the distribution of their ads to publishers by way of ad servers 106. The search web server 102 and the ad server 106 may both be part of the same entity, such as Yahoo!®, but not necessarily.

The search web server 102 receives a search query from a consumer 110 through a client computer 110, calculates relevant results based on the search query and returns relevant results to the client computer 108 after analyzing the search query. For example, the query may be “digital camera”. The relevant results may be a listing of websites, including http://www.cnet.com for example. When the consumer 110 clicks on any of the search results, the search web server 102 logs the query and click information of the consumer 110, and the search web server 102 redirects the consumer 110 to a publisher website issued by the publisher web server 104. For example, the search web server 102 redirects the consumer 110 to http://www.cnet.com for example. The search web server 102 may pass along the search query (e.g., “digital camera”) as additional search intent parameters, or query string, in with the URL (uniform resource locator) that the search web server 102 sends to the publisher web server 104. Information is encrypted to maintain the privacy of the search engine consumer 110.

The search engine shares search intent with a publisher by sending the search intent from the search web server 102 to the publisher web server 104. The publisher may use the search intent to improving ad targeting by himself. Alternatively, the publisher can pass the search intent info onto an ad server 106 that can use that information with other factors to do additional customization of ad. The search engine can charge the publisher passing the search intent from the search web server 102 to the publisher web server.

The publisher web server 104 receives the request to send the information to the search web server 102. The publisher web server 104, for example, sees the search intent in the URL passed from the search web server 102. The publisher web server 104 may then send the search intent to the ad server 106. This may involve customizing the java script code on the browser to send these parameters with other information such as browser cookies to the ad server 106. The search engine may charge the publisher for doing passing along the search intent and for the capability of passing the search intent to an ad agency.

The ad server 106 can do additional customization on the search intent passed, so that it can further optimize the ad impression/text ads to be sent back for the consumer 110 on the publisher website. For example, instead of showing generic ads for the CNET.com website, the publisher can now display more targeted ads directed toward digital cameras. The ad server 106 in this architecture may be, for example, the publisher himself, an ad network such as DoubleClick® or an ad exchange such as RightMedia, among other things.

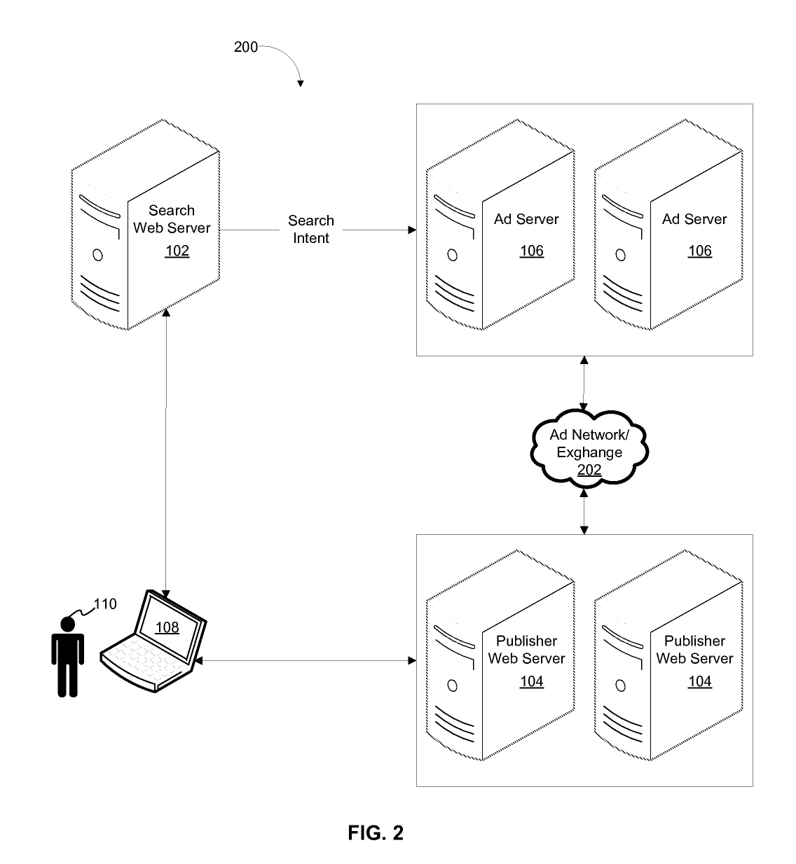

FIG. 2 is a schematic diagram of a system 200 configured to send search intent to an ad network or ad exchange, in accordance with an embodiment of the present invention. The system includes, but is not limited to, a search web server 102, publisher web servers 104 and ad servers 106, which may be a part of a larger ad-network/exchange 202. The search web server 102 is coupled to the ad servers 106, which are coupled to the publisher web servers 104. Each of these apparatuses includes devices as described above with reference to FIG. 1.

The search web server 102 shares the search query information in a user anonymous way with the advertising networks/exchanges for ad optimization across the internet for that user. The search web server 102 can charge the ad-exchange/ad-network revenue for passing along the search query information. In the current marketplace, very few ad-networks do ad optimizations at a user level, by constructing a user profile for ad-targeting. As online advertising matures, such optimization techniques would be a differentiating factor between various networks, and ad-exchanges would highly value this information in order to improve ad targeting.

The search web server 102 receives a search query from a consumer 110 through a client computer 110, calculates relevant results based on the search query and returns relevant results to the client computer 108 after analyzing the search query. The search web server 102 substantially asynchronously sends the search intent to various ad servers 106 in ad networks/exchanges 202 who subscribe to search events at a user level, topic level or publisher level. The search web server 102 can pass along the search query as additional search intent parameters, or query string, in with the URL that the search web server 102 sends to the ad servers 106. Information is encrypted to maintain the privacy of the search engine consumer 110. The subscribe process can be carried out using an Internet application with a front end that provides choices to the ad network/exchange 202 for receiving the related events from the search web server 102.

An ad server 106 can do further optimization of the ad to be shown across publishers site in the network, based on the search intent. For example, an ad server 106 may follow up with a display ad for search keywords in order to increase the ad relevancy when the consumer 110 reaches a publisher in the ad-network affiliated with the particular ad server 106 based on the IP (Internet Protocol) address or cookie of the consumer 110. However, the cookie does not expose too much information, as maintaining privacy information is important. The ad server 106 may be, for example, a server hosted in the Yahoo!® network, among other things.

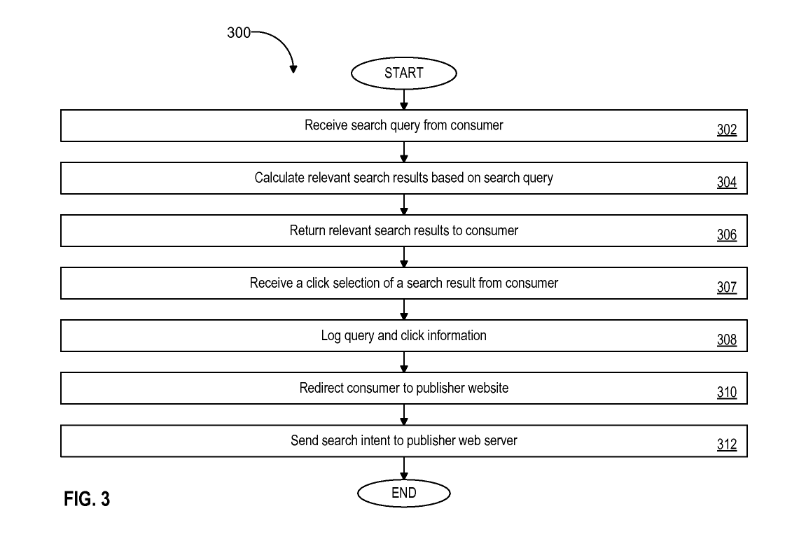

FIG. 3 is a flowchart of a method 300 carried out by a search web server involving passing search intent from the search web server to a publisher web server, in accordance with an embodiment of the present invention. The method 300 starts in step 302 where the search web server receives a query from a consumer through a client computer. Next, in step 304, the search web server calculates relevant search results based on the search query. The search web server then returns relevant search results to the client computer for the consumer in step 306. When the consumer clicks on any of the search results, in step 307 the search web server receives the click selection of the particular search result. The method 300 then moves to step 308 where the search web server logs query and click information. In step 310, the search web server then redirects the consumer to the publisher website that hosts the page associated with the clicked link. Next, in step 312, the search web server sends the search intent to the publisher web server. The method 300 is then at an end.

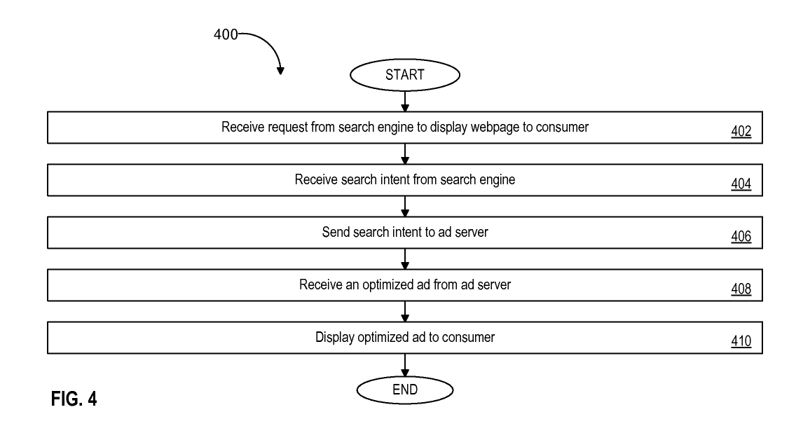

FIG. 4 is a flowchart of a method 400 carried out by a publisher web server involving passing search intent to an ad server, in accordance with an embodiment of the present invention. The method 400 starts in step 402 where the publisher web server receives a request from a search web server to display the publisher's webpage to a consumer. In step 404, the publisher web server also receives the search intent from the search web server. The method 400 then moves to step 406 where the publisher web server sends the search intent to an ad server for further ad optimization. In step 408, the publisher web server then received an optimized ad from the ad server. The method 400 then moves to step 410 where the publisher web server displays the optimized to the consumer. The method 400 is then at an end.

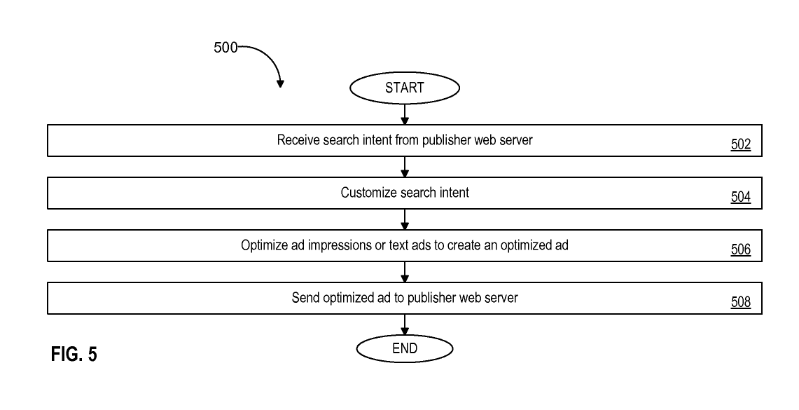

FIG. 5 is a flowchart of a method 500 carried out by an ad server involving receiving search intent from a publisher web server, in accordance with an embodiment of the present invention. The method 500 starts in step 502 where the ad server receives search intent from a publisher web server. Next, in step 504, the ad server may perform additional customization on the search intent. The ad server then optimizes ad impression or text ads to create an optimized ad in step 506. The method 500 then moves to step 508 where the ad server sends the optimized ad to the publisher web server. The method 500 is then at an end.

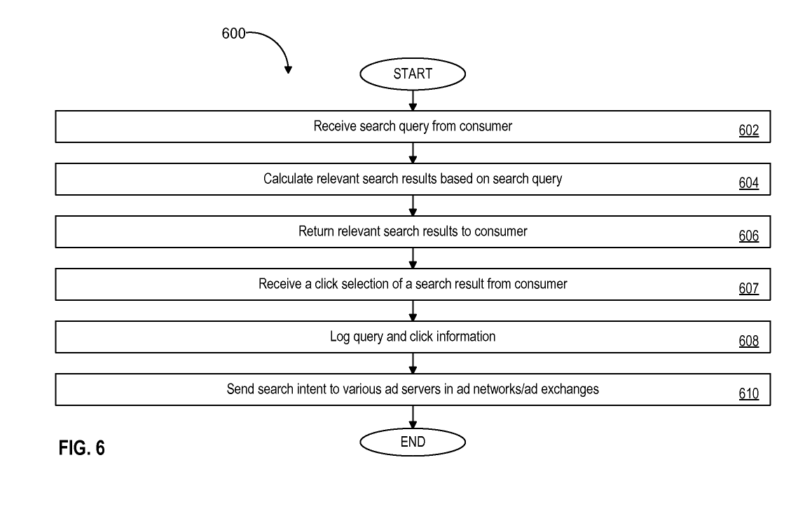

FIG. 6 is a flowchart of a method 600 carried out by a search web server involving passing search intent to an ad network or ad exchange, in accordance with an embodiment of the present invention. The method 600 starts in step 602 where the search web server receives a query from a consumer. Next, in step 604, the search web server calculates relevant search results based on the search query. When the consumer clicks on any of the search results, in step 607 the search web server receives the click selection of the particular search result. The method 600 then moves to step 608 where the search web server logs query and click information. Next, in step 610, the search web server sends the search intent to one or more ad servers in an ad network/exchange. The method 600 is then at an end.

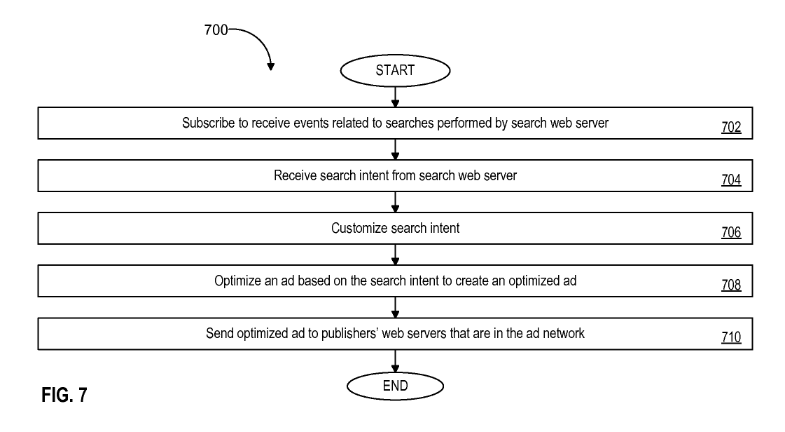

FIG. 7 is a flowchart of a method 700 carried out by an ad server involving receiving search intent from a search web server, in accordance with an embodiment of the present invention. The method 700 starts in step 702 where the ad server subscribes with the search web server to receive events related to searches performed by the search web server. In step 704, the ad server then receives search intent from a publisher web server. Next, in step 706, the ad server may perform additional customization on the search intent. The ad server then optimizes ad impression or text ads to create an optimized ad in step 708. The method 700 then moves to step 708 where the ad server sends the optimized ad to publishers' web servers that are in the ad network. The method 700 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMS, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to receiving a search query from a consumer, calculating relevant search results based on the search query, returning relevant search results to the consumer, receiving a click selection of a search result from the consumer, logging search query information and user click information, redirecting the consumer to a website of the publisher web server, and sending the search intent to the publisher web server, according to processes of the present invention.

### Advantages

Before the present invention, there were no tools to target ads beyond a search engine, such as Yahoo!®. The search engine logs the search intent and shows display ads using it as one of the variables for targeting. It is desirable for the search engine to extend these capabilities to multiple publishers in order to make it attractive for the publishers to work with the search engine. Studies have revealed that search advertising campaigns are most effective if the consumer is provided a display ad. The method of present invention provides a method of ad monetization by sharing search intent with publishers and ad networks/exchanges so that the advertiser can target the consumer with a display ad on the fly on any site on the Internet.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of passing search intent to a publisher web server, the method comprising:
receiving a search query from a consumer;
calculating relevant search results based on the search query;
returning relevant search results to the consumer;
receiving a click selection of a search result from the consumer;
logging search query information and user click information;
redirecting the consumer to a website of the publisher web server; and
sending the search intent to the publisher web server.

2. The method of claim 1, wherein the method is carried out by a search web server.

3. The method of claim 1, wherein the search intent is information of the search query passed along as additional search intent parameters in a URL (uniform resource locator).

4. The method of claim 1, further comprising encrypting the search intent to maintain the privacy of the consumer.

5. The method of claim 1, wherein the search intent is key words of the search query.

6. The method of claim 1, further comprising charging the publisher web server for passing along the search intent to the publisher web server.

7. An apparatus for passing search intent to a publisher web server, the apparatus comprising:
a receiver device configured to receive a search query from a consumer;
a processor device configured to calculate relevant search results based on the search query;
a sender device configured to return relevant search results to the consumer, wherein the receiver is further receive a click selection of a search result from the consumer, wherein the processor device is further configured to log search query information and user click information, wherein the processor device is further configured to redirect the consumer to a website of the publisher web server, and wherein the sender device is further configured to send the search intent to the publisher web server.

8. The apparatus of claim 7 wherein the apparatus is a search web server configured to carry out processes of a search engine.

9. The apparatus of claim 7, wherein the search intent is information of the search query passed along as additional search intent parameters in a URL (uniform resource locator).

10. The apparatus of claim 7, wherein the processor device is further configured to encrypt the search intent to maintain the privacy of the consumer.

11. The apparatus of claim 7, wherein the search intent is key words of the search query.

12. The apparatus of claim 7, wherein the processor device is further configured to charge the publisher web server for passing along the search intent to the publisher web server.

13. An apparatus for receiving search intent from a publisher web server, the apparatus comprising:
a receiver device configured to receive the search intent from a publisher web server;
a process device configured to customize the search intent and to optimize an ad to create an optimized ad; and
a sender device configured to send the optimized ad to the publisher web server.

14. The apparatus of claim 13, wherein the apparatus is an ad server.

15. A method of passing search intent to one or more ad servers, the method comprising:
receiving a search query from a consumer;
calculating relevant search results based on the search query;
returning relevant search results to the consumer;
receiving a click selection of a search result from the consumer;
logging search query and user click information; and
sending the search intent to the one or more ad servers.

16. The method of claim 15, wherein the method is carried out by a search web server.

17. The method of claim 15, wherein the search intent is information of the search query passed along as additional search intent parameters in a URL (uniform resource locator).

18. The method of claim 15, further comprising encrypting the search intent to maintain the privacy of the consumer.

19. The method of claim 15, wherein the search intent is key words of the search query.

20. The method of claim 15, further comprising charging the one or more ad servers for passing along the search intent to the one or more ad servers.

21. An apparatus for passing search intent to one or more ad servers, the apparatus comprising:
a receiver device configured to receive a search query from a consumer;
a processor device configured to calculate relevant search results based on the search query;
a sender device configured to return relevant search results to the consumer, wherein the receiver device is further configured to receive a click selection of a search result from the consumer, wherein the processor device is further configured to log search query and user click information, and wherein the sender device if further configured to send the search intent to the one or more ad servers.

22. The apparatus of claim 21, wherein the apparatus is a search web server.

23. The apparatus of claim 21, wherein the search intent is information of the search query passed along as additional search intent parameters in a URL (uniform resource locator).

24. The apparatus of claim 21, wherein the processor device is further configured to encrypt the search intent to maintain the privacy of the consumer.

25. The apparatus of claim 21, wherein the search intent is key words of the search query.

26. The apparatus of claim 21, wherein the processor device is further configured to charge the one or more ad servers for passing along the search intent to the one or more ad servers.

27. An apparatus for receiving search intent from a search web server, the apparatus comprising:
a receiver device configured to receive a search intent from the search web server;
a processor device configured to customize the search intent and to optimize the search intent to create an optimized ad; and
a sender device configured to send the optimized ad to a publisher web server.

28. The apparatus of claim 27, wherein the apparatus is one of an ad server, an ad network and an ad exchange.

29. A computer readable medium carrying one or more instructions for passing search intent to a publisher web server, wherein the one or more instructions, when executed by one or more processors, cause the one or more processors to perform the steps of:
receiving a search query from a consumer;
calculating relevant search results based on the search query;
returning relevant search results to the consumer;
receiving a click selection of a search result from the consumer;
logging search query information and user click information;
redirecting the consumer to a website of the publisher web server; and
sending the search intent to the publisher web server.
